(19) United States
(12) Patent Application Publication
(10) Pub. No.: US 2006/0194664 A1
(43) Pub. Date: Aug. 31, 2006

(54) Half pitch chain structure for a show bike

(76) Inventor: Wen-Pin Wang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/066,211

(22) Filed: Feb. 28, 2005

(51) Int. Cl. F16G 13/02

(52) U.S. Cl. 474/206; 474/209

(57) ABSTRACT

A half pitch chain structure for a show bicycle includes chain plates, sleeves, rollers, and pins. Each chain plate comprises an outer link portion at one end and an inner link portion at the opposite end. The inner link portion of one chain plate is connected with the outer link portion of another adjacent chain plate to form a slot therein. The slot has a wide section and a narrow section. The top end of each adjacent chain plate is at the same height level without any differential level.

### BACKGROUND OF THE INVENTION

1. Filed of the Invention

This invention relates to a half pitch chain structure for a show bike, and more particularly to a chain plate having an outer link portion at one end and an inner link portion at the other end. The inner link portion of one chain plate is connected with the outer link portion of another adjacent chain plate to form a slot therein. Each chain plate is at the same height level with each other.

2. Description of the Prior Art

A conventional chain A for a show bike, as shown in FIGS. 6 and 7, is to insert rollers A3, and sleeves A4 into the space between outer chain plates A1 and inner chain plates A2. The sleeves A4 are inserted with pins A5 for securing purpose. The outer chain plates A1 are connected with the inner chain plates, by repeating doing this to form a complete chain. Each chain plate set has a differential B in height with each other. This differential B will cause the top portion of the chain plate set to vibrate, which affects the stability and the speed of the bike.

Moreover, when it is desire to cut down the length of the chain A, one set of the outer chain plates A1 and the inner chain plates A2 has to be dismantled at the same time, which is time consuming.

### SUMMARY OF THE INVENTION

It is the primary objective of the present invention to provide a half pitch chain structure for a show bike, which provides a slot to mesh with teeth of a gear. The slot has a wide section and a narrow section so as to easily engage and to mesh in a tightening way.

It is another objective of the present invention to provide a half pitch chain structure for a show bike, which has a flat top portion to save time in length adjustment.

It is a further objective of the present invention to provide a half pitch chain structure for a show bike, which has a flat top portion that is safe for a rider.

### BRIEF DESCRIPTION OF THE DRAWINGS

FIG. 1 is an exploded view of the present invention;

FIG. 2 is a perspective view of the assembly of the present invention;

FIG. 3 is a side view of FIG. 2;

FIG. 4 is a top view of FIG. 2;

FIG. 5 is a side view of the present invention meshing with a gear;

FIG. 6 is an exploded view of a prior art; and

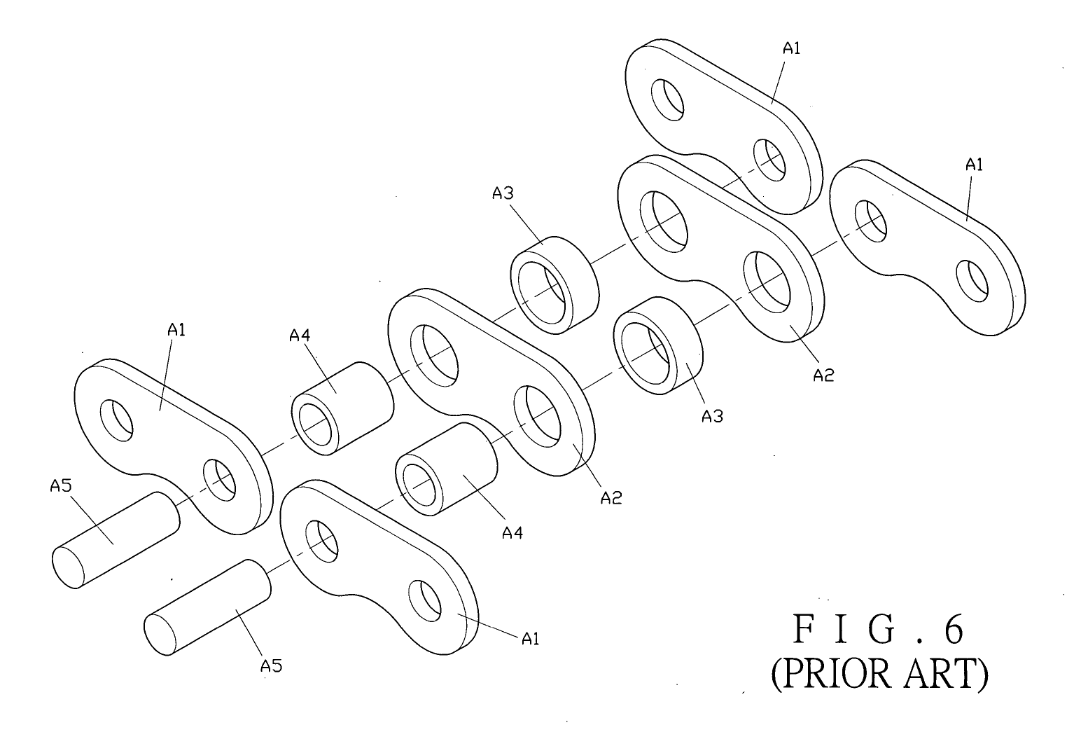

FIG. 7 is a side view of FIG. 6.

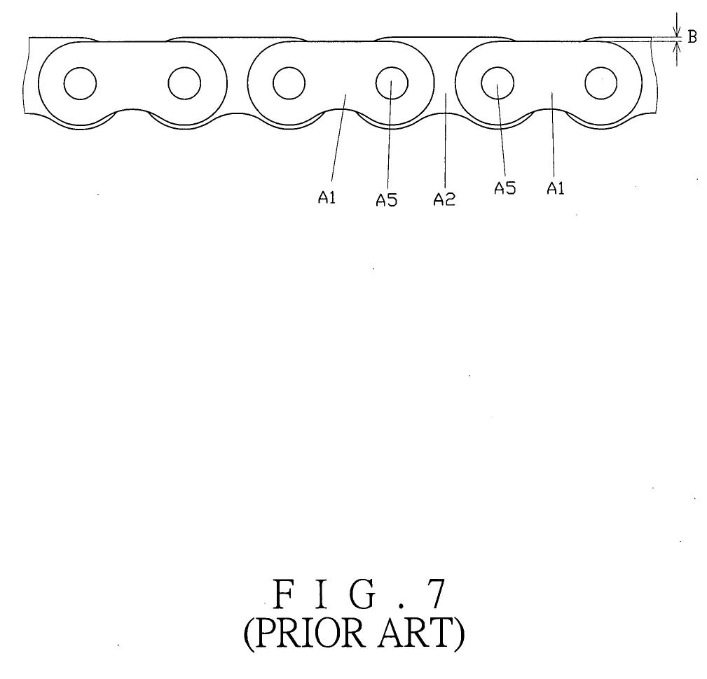

### DETAILED DESCRIPTION OF THE PREFERRED EMBODIMENT

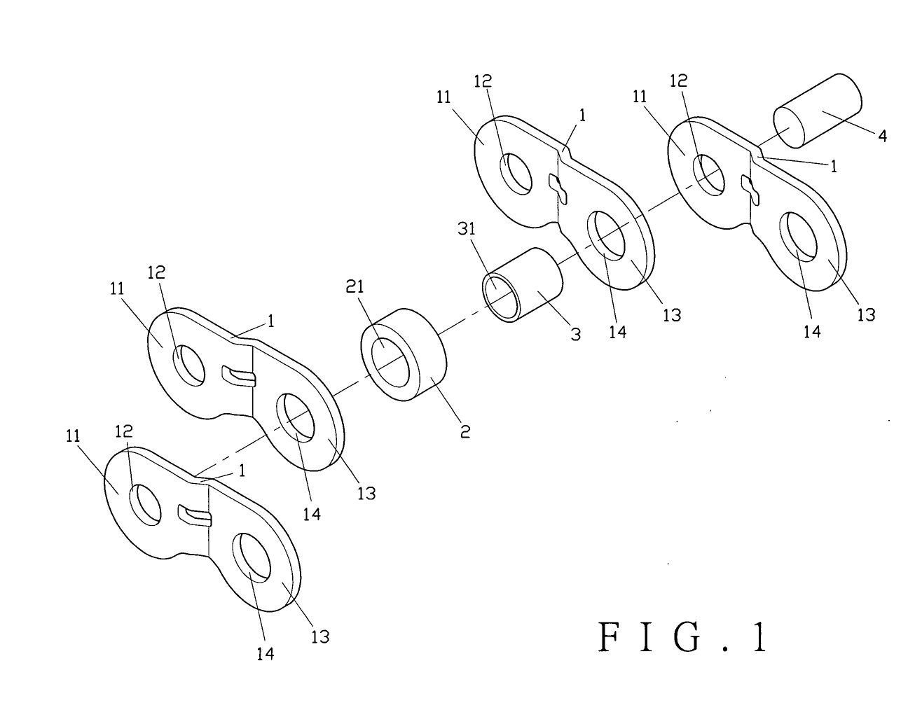

As shown in FIG. 1, the present invention comprises chain plates 1, sleeves 2, rollers 3, and pins 4.

The chain plates 1 are pivotally connected with each other. Each chain plate 1 comprises an outer link portion 11 at one end with a first connecting hole 12 thereat and an inner link portion 13 formed at the other end opposite the outer link portion 11. The inner link portion 13 has a second connecting hole 14 thereat.

Each roller 2 is placed in between the inner link portions 13 of every two chain plates 1, and comprises a third connecting hole 21 therein.

Each sleeve 3 is placed in the third connecting hole 21 of the roller 2, and comprises a fourth connecting hole 31 therein.

Each pin 4 is inserted into the fourth connecting hole 31 of the sleeve 3, the first connecting hole 12 of the outer link portion 11 of one chain plate 1, and the second connecting hole 14 of the inner link portion 13 of another adjacent chain plate 1.

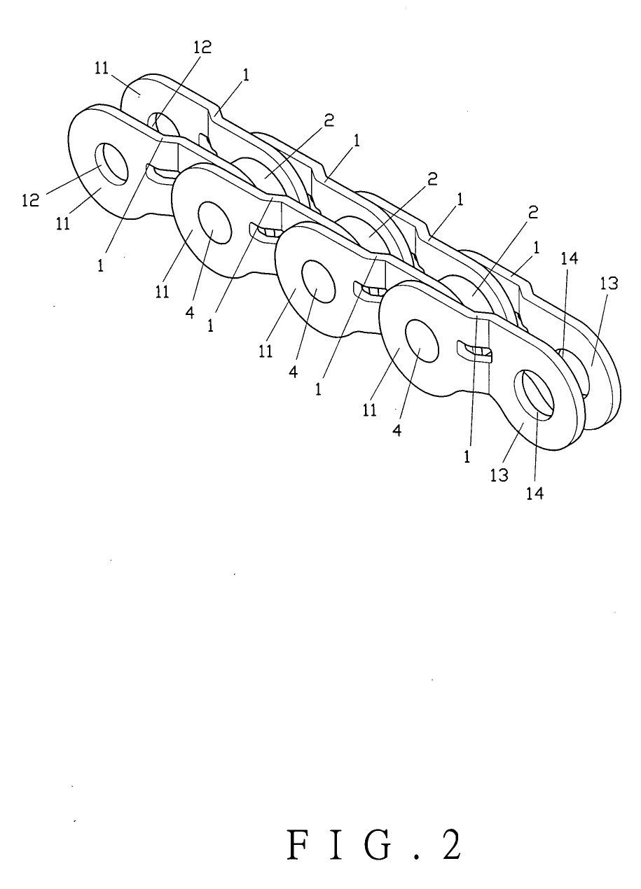

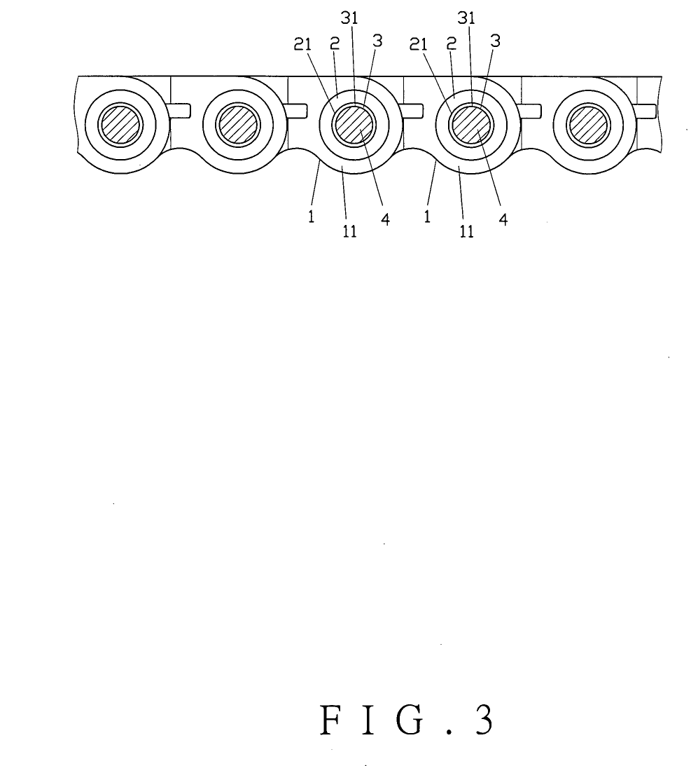

To assemble the present invention, as shown in FIG. 2, place each chain plate 1 against each other with the outer link portion 11 facing the inner link portion 13 of another adjacent chain plate 1, while the second connecting hole 14 is aligned with the first connecting hole 12. The roller 2 is placed between the inner link portions 13 of each chain plate set. The sleeve 3 is inserted into the third connecting hole 21 of the roller 2. The pin 4 is inserted into the first connecting hole 12 and the second connecting hole 14 of the adjacent chain plates 1 and the fourth connecting hole 31 of the sleeve 3. By repeating these steps, a chain loop is formed. The top end of each adjacent chain plate 1 is flat and stays at the same height level, as shown in FIG. 3, which prevents the chain loop from shake or vibration when the bike is in use.

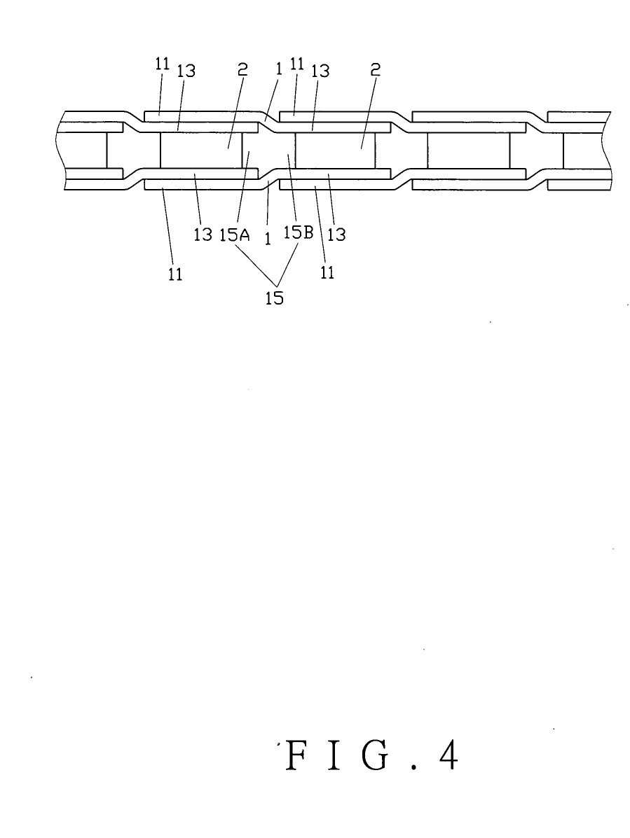

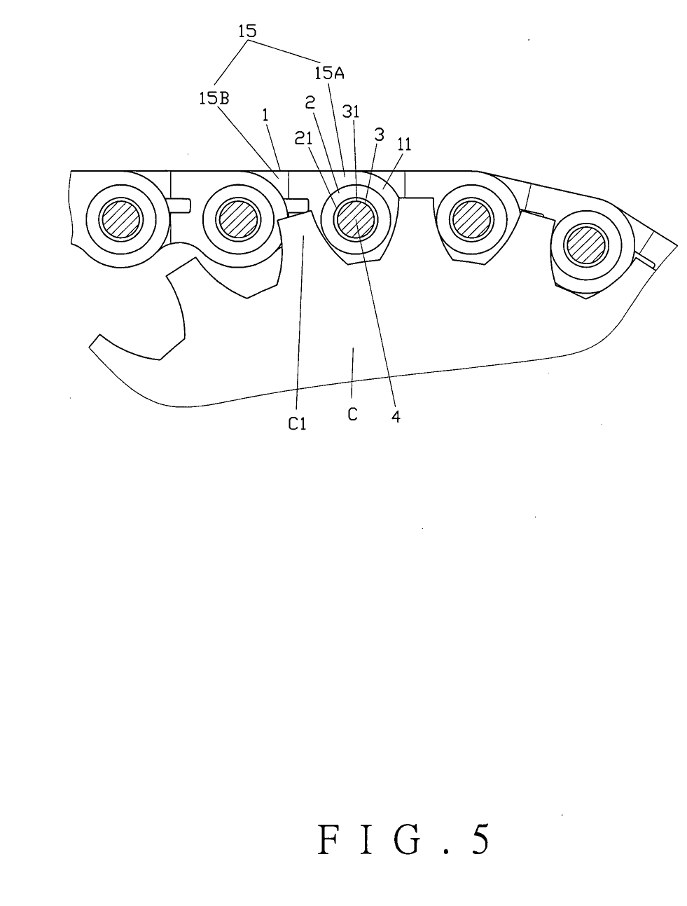

After assembly, a slot 15 is formed therein between the inner link portions 13 and the outer link portions 11 of each chain plate set, as shown in FIG. 4. The slot 15 has a wide section 15A and a narrow section 15B. When meshing with a gear C, the wide section 15A will engage with the teeth C1 of the gear C, as shown in FIG. 5, and the narrow section 15B will engage with the teeth C1 thereafter.

To cut down the length of the chain loop, simply hammer one pin 4 off from the inner link portion 13 and the outer link portion 11 of one chain plate set, while the roller 2 and the sleeve 3 take away one outer link portion 11 and one inner link portion 13, and then insert the roller 2, the sleeve 3 and the pin 4 back, thus the length of the chain loop is shortened.

What is claimed is:

1. A half pitch chain structure for a show bike comprising:
chain plates to be connected with each other;
rollers to be placed between every said two chain plates;
sleeves to be inserted into said rollers;
pins to be inserted into said sleeves to connect said chain plates, and characterized in that:
each chain plate comprising an outer link portion at one end and an inner link portion at another end thereof, said inner link portion being connected with said outer link portion of another adjacent chain plate to form a slot having a wide section and a narrow section.

2. The half pitch chain structure for a show bike, as recited in claim 1, wherein said outer link portion comprises a first connecting hole, and said inner link portion comprises a second connecting hole aligned with said first connecting hole of the adjacent chain plate for insertion of said pin.

3. The half pitch chain structure for a show bike, as recited in claim 1, wherein said roller is placed in between said inner link portions of every said two chain plates and comprises a third connecting hole for insertion of said sleeve, and said sleeve comprises a fourth connecting hole for insertion of said pin.

4. A half pitch chain structure for a show bike comprising:
chain plates to be connected with each other;
rollers to be placed in between every said two chain plates;
sleeves to be inserted into said rollers to connect said chain plates, and characterized in that:
when said chain plates are pivotally connected to form a chain loop, the top end of each adjacent chain plate being at the same height level.

5. The half pitch chain structure for a show bike, as recited in claim 4, wherein each chain plate comprises a first connecting hole and a second connecting hole, said first connecting hole being aligned with said second connecting hole of another adjacent chain plate for insertion of said pin.

6. The half pitch chain structure for a show bike, as recited in claim 4, wherein said roller is placed in between said first connecting hole and said second connecting hole of the adjacent chain plate and comprises a third connecting hole for insertion of said sleeve, and said sleeve comprises a fourth connecting hole for insertion of said pin.
